(19) United States
(12) Patent Application Publication
(10) Pub. No.: US 2012/0317810 A1
(43) Pub. Date: Dec. 20, 2012

(54) METHOD FOR MAKING A METAL REINFORCEMENT FOR THE BLADE OF A TURBINE ENGINE

(75) Inventors: Gilles Charles Casimir Klein, Mery sur Oise (FR); Stéphane André Leveque, Massy (FR); Dominique Magnaudeix, Yerres (FR); Philippe Marolle, Wissous (FR)

(73) Assignee: SNECMA, Paris (FR)

(21) Appl. No.: 13/581,063

(22) PCT Filed: Feb. 18, 2011
(86) PCT No.: PCT/EP2011/052467

§ 371 Date: Aug. 24, 2012

(30) Foreign Application Priority Data
Feb. 25, 2010 (FR) 1051364

(51) Int. Cl. B23P 15/04

(52) U.S. Cl. 29/889.71

(57) ABSTRACT

A method for making a metal reinforcement for the leading edge or trailing edge of the blade of a turbine engine that includes making a metal insert defining the base of the metal reinforcement; positioning the metal insert at the end of a blank of a shaping tool, the blank repeating the shape of the turbine-engine blade; shaping a planar metal sheet on the metal insert and the blank of the shaping tool using a superplastic hot-shaping method.

The present invention relates to a method for making a metal reinforcement for a composite or metal blade of a turbine engine.

More particularly, the invention relates to a method for making a metal reinforcement for the leading edge of a turbine engine blade.

The field of the invention is that of turbine engines and more particularly that of fan blades, made of composite or metal material, of a turbine engine and whereof the leading edge comprises a metal structural reinforcement.

However, the invention is also applicable to making a metal reinforcement intended to reinforce a trailing edge of a turbine engine blade.

It will be recalled that the leading edge corresponds to the front part of an aerodynamic profile which faces the air flow and which divides the air flow into a lower-surface air flow and an upper-surface air flow. The trailing edge corresponds to the rear part of an aerodynamic profile where the lower-face and upper-face flows are united.

It is known to provide the fan blades of a turbine engine, produced in composite materials, with a metal structural reinforcement extending over the whole height of the blades and beyond their leading edge, as mentioned in document EP 1809918. Such a reinforcement permits the composite blades to be protected during an impact of a foreign body on the fan, such as for example a bird, hail or stones.

In particular, the metal structural reinforcement protects the leading edge of the composite blade by preventing risks of delamination, fibre rupture or damage due to fibre/matrix de-cohesion.

Conventionally, a turbine engine blade comprises an aerodynamic surface extending, in a first direction, between a leading edge and a trailing edge and, in a second direction essentially perpendicular to the first direction, between a foot and a head of the blade. The metal structural reinforcement assumes the shape of the leading edge of the aerodynamic surface of the blade and extends in the first direction beyond the leading edge of the aerodynamic surface of the blade assuming the shape of the profile of the lower face and the upper face of the blade and in the second direction between the foot and the head of the blade.

In a known manner, the metal structural reinforcement is a metal part produced entirely by milling from a block of material.

However, the metal reinforcement of a leading edge of a blade is a part that is complex to produce, requiring numerous complex reworking and tooling operations involving high production costs.

In this context, the invention aims to solve the aforementioned problems by proposing a method for making a metal reinforcement for the leading edge or the trailing edge of a turbine engine blade, permitting the production costs of such a part to be significantly reduced, whilst at the same time simplifying the production range.

For this purpose, the invention proposes a method for making a metal reinforcement for the leading edge or the trailing edge of a turbine engine blade, said method comprising sequentially:
a step for making a metal insert defining the base of the metal reinforcement;
a step for positioning said metal insert on the end of a blank of a shaping tool, said blank assuming the shape of said turbine engine blade;
a step for shaping a planar metal sheet on said metal insert and on said blank of said tool using a super plastic hot-forming process.

Thanks to the invention, the metal structural reinforcement is made in a straightforward and rapid manner on the basis of a blank made in a shaping tool and assuming the external profile of a turbine engine blade, a tool, a metal insert conventionally made by machining and a metal sheet shaped on said blank and on said insert by a super plastic hot-forming process (SPF for Super Plastic Forming in English).

The hot forming also permits the insert to be rigidly connected to the metal sheet shaped in the tool, in such a way that the assembly constituted by the shaped metal sheet and the insert respectively form the sides and the base of the metal reinforcement of the turbine engine blade.

This method of making thus makes it possible to be free from the complex production of the reinforcement by milling in the body from flat bars requiring a large volume of material to be used and consequently high costs for the supply of the initial material.

The method according to the invention also makes it possible to reduce considerably the production costs of such a part.

The method for making a metal reinforcement for a turbine engine blade according to the invention can also comprise one or more of the below-mentioned features, considered individually or in all technically possible combinations:
said step for positioning said metal insert is carried out by positioning the lower face of said insert, having a shape complementary with said shape of the end, on said end of said blank;
said method comprises a step of diffusion welding of said insert and said metal sheet simultaneously with said shaping step;
said method comprises a step for mould-removal of said metal reinforcement from said tool;
said method comprises a step for finishing said metal reinforcement consisting in a sub-step for polishing the surface of said reinforcement and/or in a sub-step for reworking the profile and/or the thicknesses of the sides of said reinforcement and/or in a sub-step for reworking the profile of the base of the reinforcement;
said step for reworking the profile and/or the thicknesses of the sides of said reinforcement is carried out by chemical machining;
said method comprises a step for preparing the metal sheet consisting in a sub-step of preliminary machining of certain zones of the metal sheet and/or in a sub-step of increasing the roughness on the lower face of said metal sheet;
said method comprises an operation consisting in increasing the roughness of the inner faces of said sides of said reinforcement.

Other features and advantages of the invention will emerge more clearly from the description thereof given below, by way of indication and on no account limiting, making reference to the appended figures, amongst which:

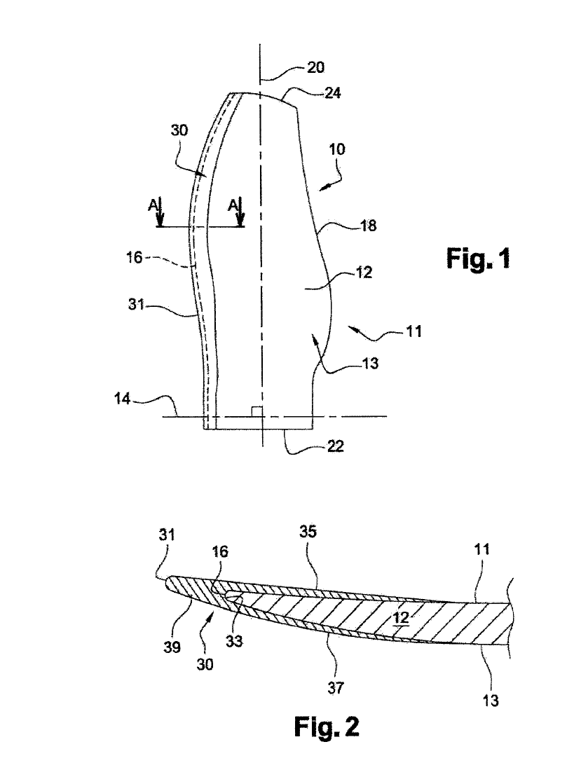

FIG. 1 is a side view of a blade comprising a metal structural reinforcement of the leading edge obtained by means of the method of making according to the invention;

FIG. 2 is a partial cross-sectional view of FIG. 1 in a plan view of cross-section AA;

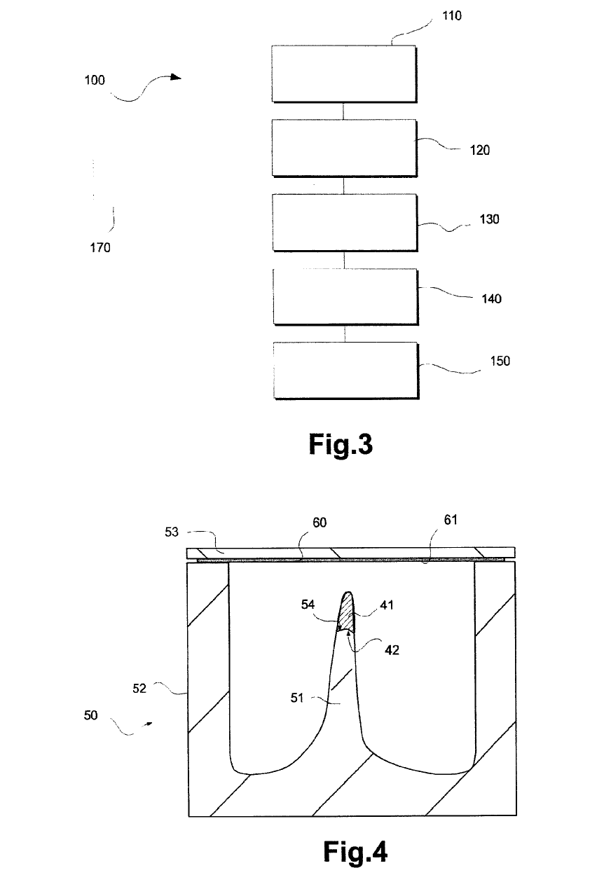

FIG. 3 is a block diagram showing the main steps for making a metal structural reinforcement of the leading edge of a turbine engine blade of the method of making according to the invention;

FIG. 4 is a view illustrating the initial state of the reinforcement during the third step of the method for making a metal reinforcement of the leading edge of a turbine engine blade illustrated in FIG. 3;

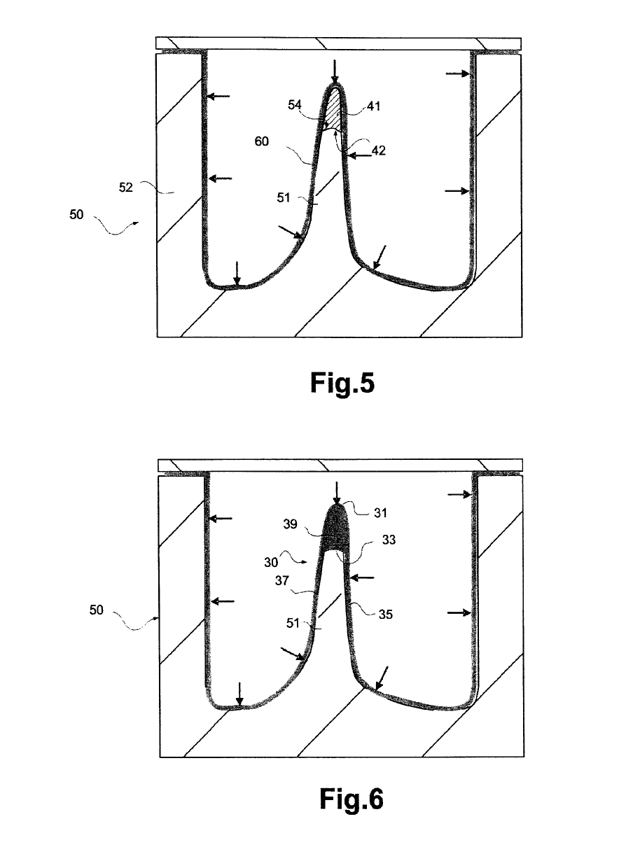

FIG. 5 is a view illustrating the intermediate state of the reinforcement during the third step of the method for making a metal reinforcement of the leading edge of a turbine engine blade illustrated in FIG. 3;

FIG. 6 is a view illustrating the final state of the reinforcement during the third step of the method for making a metal reinforcement of the leading edge of a turbine engine blade illustrated in FIG. 3;

In all the figures, common elements have the same reference numbers unless stated to the contrary.

FIG. 1 is a side view of a blade comprising a metal structural reinforcement of the leading edge obtained by means of the method of making according to the invention.

Illustrated blade 10 is for example a mobile fan blade of a turbine engine (not represented).

Blade 10 comprises an aerodynamic surface 12 extending in a first axial direction 14 between a leading edge 16 and a trailing edge 18 and in a second radial direction 20 essentially perpendicular to first direction 14 between a foot 22 and a head 24.

Aerodynamic surface 12 forms an upper surface 13 and a lower surface 11 of blade 10, only upper surface 13 of blade 10 being represented in FIG. 1. Lower surface 11 and upper surface 13 form the lateral faces of blade 10 which connect leading edge 16 to trailing edge 18 of blade 10.

In this embodiment, blade 10 is a composite blade typically obtained by draping a woven composite material. By way of example, the composite material used can comprise an assembly of woven carbon fibres and a resin matrix, the assembly being formed by moulding by means of a resin injection process under vacuum of the RTM type (standing for “Resin Transfer Moulding”).

Blade 10 comprises a metal structural reinforcement 30 glued at its leading edge 16 and which extends both in first direction 14 beyond leading edge 16 of aerodynamic surface 12 of blade 10 and in second direction 20 between foot 22 and head 24 of the blade.

As represented in FIG. 2, structural reinforcement 30 assumes the shape of leading edge 16 of aerodynamic surface 12 of blade 10 which it extends to form a leading edge 31, so-called leading edge of the reinforcement.

Conventionally, structural reinforcement 30 is a one-piece part comprising an essentially V-shaped section having a base 39 forming leading edge 31 and extended by two lateral sides 35 and 37 respectively assuming the shape of lower surface 11 and upper surface 13 of aerodynamic surface 12 of the blade. Sides 35, 37 have a profile that tapers or thins out in the direction of the trailing edge of the blade.

Base 39 has a rounded inner profile 33 capable of assuming the rounded shape of leading edge 16 of blade 10.

Structural reinforcement 30 is metallic and preferably titanium-based. This material in fact has a great capacity for energy absorption due to impacts. The reinforcement is glued on blade 10 by means of glue known to the person skilled in the art, such as for example a cyanoacrylic glue or epoxy glue.

This type of metal structural reinforcement 30 used for the reinforcement of a composite turbine engine blade is more particularly described notably in patent application EP 1908919.

The method according to the invention makes it possible to make a structural reinforcement such as illustrated in FIG. 2, FIG. 2 illustrating reinforcement 30 in its final state.

FIG. 3 represents a block diagram illustrating the main steps of a method of making 100 a metal structural reinforcement 30 of the leading edge of a blade 10 as illustrated in FIGS. 1 and 2. First step 110 of method of making 100 is a step for fabricating a metal insert 41 by conventional means of machining known to the person skilled in the art. Metal insert 41 is machined in such a way as to represent essentially the profile and the shape of base 39 of metal reinforcement 30 in its final state.

For this purpose, the sides of metal insert 41 are machined in such a way as to assume the lower-surface and upper-surface shape of metal reinforcement 30 and lower face 42 of insert 41 is machined in such a way as to correspond to the shape of rounded inner profile 33 suitable for assuming the rounded shape of leading edge 16 of blade 10.

Second step 120 of method of making 100 is a step for positioning, or docking, insert 41 at the end of a blank 51 provided in a shaping tool 50.

Shaping tool 50 comprises a lower part 52 comprising blank 51 and an upper part 53 covering lower part 52 in a tight manner.

Blank 51 is made in such a way as to form the curvature and the desired lower-surface and upper-surface profile of metal reinforcement 30. To advantage, blank 51 essentially comprises the same profile as the blade on which the metal reinforcement is to be assembled.

Upper face 54 of blank 51 is made in such a way as to correspond to the complementary shape of lower face 42 of insert 41 which corresponds to the shape of inner profile 33 of reinforcement 30.

Thus, the positioning of insert 41 on blank 51 is carried out by fitting lower face 42 on upper face 54 of blank 51 in such a way that the Assembly forms a profile equivalent to the shape of the inner part of metal reinforcement 30.

Third step 130 of method of making 100 is a hot-forming step of a planar metal sheet 60 placed in shaping tool 50 between lower part 52 and upper part 53 closing the tool in a tight manner.

In its initial state (FIG. 4), planar metal sheet 60 is held braced at its ends between the two parts 52, 53 of tool 50. The hot-forming step consists in using the property of metals which have a capacity to be deformed without rupture at a given temperature, such as for example aluminium or titanium. By way of example, titanium under certain temperature conditions, for example at 940° C., has an expansion rate greater than 35%.

By way of example, a hot-forming process used for this step can be a super plastic forming process (SPF for Super Plastic Forming in English).

Super plastic forming is a process which makes it possible to produce complex parts of metal sheet with small thicknesses and in a single operation.

For the implementation of this process, planar metal sheet is heated to a given temperature, for example to a temperature equivalent to half the melting temperature of the material. At this temperature, metal sheet 60 is deformed by the pressure of a neutral gas, for example argon, introduced inside tool 50 closed as represented in FIG. 5. The evolution in this gas pressure, represented by the arrows in FIG. 5, is controlled in such a way that the shaping of metal sheet 60b, on insert 41 and on blank 51, is carried out in the super plastic region which is associated with a deformation rate range specific to each family of material. In a known manner, the prediction of the law of the evolution of the forming pressure is carried out by numeric simulation in such a way as to optimise the shaping and the cycle time of such a process.

During the hot-forming step, and once metal sheet 60 has been shaped, the temperature and pressure conditions inside shaping tool 50 continue to be applied in such a way as to rigidly connect insert 41 by diffusion welding, as illustrated in FIG. 6. Diffusion welding employs the principle of the diffusion of atoms to create a mechanical bond. The tightness of shaping tool 50 makes it possible to be free from risks of contamination of parts during the diffusion welding, thus permitting a quality weld to be obtained.

This step of hot-forming planar metal sheet 60 can optionally be preceded by a step 170 for preparing metal sheet 60 before its hot deformation.

This preparation step 170 consists for example in a step for preliminary machining of certain zones of metal sheet in such a way as to obtain locally thicknesses approaching the final thicknesses of sides 35, 57 of metal reinforcement 30 while metal sheet 60 is being shaped.

By way of example, the local machining of planar metal sheet 60 can be carried out chemically.

This step 170 for preparing planar metal sheet 60 can also comprise a step for increasing the roughness of its lower face 61, which will form the inner surface of metal reinforcement 30 in its final state.

By way of example, the roughness of lower face 61 of metal sheet 60 can also be degraded during the shaping of metal sheet 60 by hot-forming on blank 51, blank 51 previously having a degraded roughness.

Fourth step 140 of method of making 100 is a step for the mould-removal of blade metal reinforcement 30 formed by shaped metal sheet 60 and insert 41 rigidly connected to shaped metal sheet 60.

The fineness of sides 35, 37 confers a certain elasticity on the assembly, which permits removal of the piece from the mould without damage.

Fifth step 150 of method of making 100 is a step for finishing and reworking of reinforcement 30 by machining in such a way as to obtain the required thicknesses and the profile.

This reworking step 150 can comprise one or more sub-steps presented below, namely:
a first sub-step for reworking the profile of base 39 of reinforcement 30 in such a way as to refine the latter and in particular the aerodynamic profile of leading edge 31 by mechanical machining;
a second sub-step for reworking sides 35, 37; this step consisting in particular in trimming sides 35, 37 and in thinning-out the lower-surface- and upper-surface sides by chemical machining, optionally in a selective way if required;
a third finishing sub-step 59 permitting the required surface to be obtained.

In association with these main steps for the making, the method according to the invention can also comprise steps for non-destructive control of reinforcement 30, permitting the geometrical and metallurgical conformity of the obtained assembly to the ensured. By way of example, the non-destructive controls can be carried out by an x-ray method.

The method according to the invention can also comprise an additional operation for increasing the roughness following the mould-removal of reinforcement 30 from shaping tool 50 and if the roughness has not been degraded previously during step 170 for preparing metal sheet 60 or during forming step 130 by a degraded surface state of blank 51.

The method according to the invention has been described chiefly for a metal structural reinforcement on a titanium base; however, the method according to the invention is also applicable with materials on a nickel base or on a steel base.

The use of a hot-forming process and diffusion welding makes it possible to obtain structural and mechanical characteristics identical to the wrought material.

The invention has been described in particular for making a metal reinforcement of a composite turbine engine blade; however, the invention is equally applicable to making a metal reinforcement of a metal turbine engine blade.

The invention has been described in particular for making a metal reinforcement of a leading edge of a turbine engine blade; however, the invention is also applicable to making a metal reinforcement of a trailing edge of a turbine engine blade.

The other advantages of the invention are in particular the following:
reduction of production costs;
reduction of production time;
simplification of the production range;
reduction of material costs.

1. A method for making a metal reinforcement for a leading edge or a trailing edge of a turbine engine blade, said method comprising:
making a metal insert defining a base of the metal reinforcement;
positioning said metal insert on an end of a blank of a shaping tool, said blank assuming the shape of said turbine engine blade;
shaping a planar metal sheet on said metal insert and on said blank of said tool using a super plastic hot-forming process.

2. The method for making a metal reinforcement for a turbine engine blade according to claim 1, wherein said positioning is carried out by positioning a lower face of said insert, having a shape complementary with said shape of the end, on said end of said blank.

3. The method for making a metal reinforcement for a turbine engine blade according to claim 1, comprising diffusion welding said insert and said metal sheet simultaneously with said shaping.

4. The method for making a metal reinforcement for a turbine engine blade according to claim 1, comprising mould-removing said metal reinforcement from said tool.

5. The method for making a metal reinforcement for a turbine engine blade according to claim 1, comprising finishing said metal reinforcement by polishing a surface of said reinforcement and/or reworking a profile and/or thicknesses of the sides of said reinforcement and/or reworking a profile of the base of the reinforcement.

6. The method for making a metal reinforcement for a turbine engine blade according to claim 5, wherein reworking the profile and/or the thicknesses of the sides of said reinforcement is carried out by chemical machining.

7. The method for making a metal reinforcement for a turbine engine blade according to claim 1, comprising preparing the metal sheet by preliminary machining certain zones of the metal sheet and/or increasing a roughness on a lower face of said metal sheet.

8. The method for making a metal reinforcement for a turbine engine blade according to claim 1, comprising increasing a roughness of the inner faces of the sides of said reinforcement.
